(19) United States
(12) Patent Application Publication
(10) Pub. No.: US 2024/0268412 A1
(43) Pub. Date: Aug. 15, 2024

(54) PROTEIN PREPARATION PRODUCED FROM ALMOND SEEDS AND PREPARATION METHOD

(71) Applicant: Fraunhofer-Gesellschaft zur Förderung der angewandten Forschung e.V., München (DE)

(72) Inventors: Dominic WIMMER, Freising (DE); Klaus SCHREIBER, Freising (DE); Isabel MURANYI, Freising (DE); Peter EISNER, Freising (DE); Andreas STÄBLER, Freising (DE); Stephanie MITTERMAIER, Freising (DE)

(73) Assignee: Fraunhofer-Gesellschaft zur Förderung der angewandten Forschung e.V., München (DE)

(21) Appl. No.: 18/289,901

(22) PCT Filed: Mar. 11, 2022
(86) PCT No.: PCT/EP2022/056358

§ 371 Date: Nov. 8, 2023

(30) Foreign Application Priority Data
May 11, 2021 (DE) 10 2021 112 273.2

(51) Int. Cl. A23J 1/14; A21D 2/26; A23J 3/14; A23L 5/20; A23L 25/00

(52) U.S. Cl. CPC A23J 1/144; A21D 2/266; A23J 3/14; A23L 5/20; A23L 25/30

(57) ABSTRACT

The present invention relates to a protein preparation produced from almond seeds and a cost-effective method for the preparation thereof. The protein preparation has a protein content of more than 50% by mass, an oil content of less than 6% by mass, a sucrose content of less than 8% by mass and a brightness L* of greater than 70. The taste of the protein preparation is neutral, it has a light colour and is of high quality, so that it is suitable for food applications, such as emulsions and baked good, that are demanding in terms of colour and taste.

### FIELD OF APPLICATION

The invention relates to a protein preparation for food products, petfood and animal feed from almond seeds that is appealing to the senses, and a method for obtaining an almond seed protein preparation of such kind.

### PRIOR ART

As farmland and other resources are becoming more and more scarce, the importance of vegetable protein preparations for feeding humans and for use in animal food is growing. The growing demand for high-quality foodstuffs is prompting an increasing need for nutritionally and technofunctionally optimised protein preparations that can be provided simply and inexpensively.

One inexpensive source of proteins for use in human food, animal feed and petfood is the residue from pressing and extraction processes for obtaining cooking oil from almond seeds. After separation of the hard shell, almond seeds have a thin, pale to dark brown seed coat (testa), which is difficult if not impossible to separate from the seed (endosperm) in the dry state. Besides, in the case of these raw materials, there is usually no incentive to separate the seed coat before recovering the oil, as a high oil yield is desired, and the drainage of the oil can be reduced by hulling. According to the prior art, in order to increase yield when pressing to obtain almond oil, the seeds often also undergo heat treatment before de-oiling, which lowers the oil's viscosity and raises the yield. Press cakes with an oil content of less than 15% by mass, often less than 10% by mass, are then produced at high temperatures of more than 100° C. These can be ground to powder and added to foodstuffs and animal feed. The treatment at high temperatures very seriously limits the technofunctional properties, such as the solubility of the protein. Because of the unsaturated fatty acid content, the oil-containing press cake also tends to oxidise the residual fat, which can rapidly impair the sensory properties during storage. Moreover, compared with isolates from soya (protein content >90%) or peas (protein content >80%), almond preparations of such kind have a protein concentration only between 40 and 45% by mass, which makes them difficult if not impossible to use in many food applications where protein enrichment is desired.

Almond preparations are also known whose fat content after pressing is reduced to values below 2% by mass with the aid of supercritical CO2, and this improves storage stability, but also involves very high costs. Furthermore, CO2 extraction is carried out under high pressure of several hundred bar in very expensive reactors, the manufacture and operation of which are associated with high CO2 emissions. And since the process also requires a great deal of energy, and significant quantities of CO2 are released from the de-oiled flour after relaxation, protein flours that are extracted using supercritical CO2 have no significant ecological advantages over animal proteins, and in some cases even involve higher preparation costs. Furthermore, these preparations too are still brown in colour, which is also not conducive to their acceptance for food applications. Accordingly, until now there have been no light-colored preparations from almond seeds with higher protein content significantly above 50% by mass, good oxidation stability and at the same time appealing sensory properties.

### OBJECT OF THE INVENTION

The object of the present invention was to provide a protein preparation of neutral taste, light colouring and high quality from almond seeds and a simple, inexpensive production method therefor, which are suitable for food applications with exacting requirements in terms of taste, such as drinks and yoghurt, and fine baked goods such as cakes, or also emulsions such as cremes and fillings. The preparation should advantageously have the highest protein content possible, so that even small added quantities contribute to protein enrichment in foodstuffs.

### DESCRIPTION OF THE INVENTION

The object is solved with the protein preparation according to Claim 1 and the method for production thereof according to Claim 15. Advantageous variants of the method and the protein preparation may be discerned from the subordinate claims and the following description and exemplary embodiment.

The raw material for production of the protein preparation according to the invention is provided by almond seeds which have been cleaned and preferably at least partially dehulled, wherein the proportion of hulls in dry substance is less than or equal to 100% by mass, advantageously less than 75% by mass, better less than 50% by mass, particularly preferably less than 10% by mass relative to the hulls contained in native seeds, which has a positive influence on the brightness of the preparation produced therewith. The preparation according to the invention may advantageously be obtained with the method according to the invention, and is characterized by the following properties (the determination methods are presented at the end of the description, in the following text the terms fat and oil are used interchangeably):
The fat content of the preparation is less than 6% by mass, advantageously less than 4% by mass, better less than 3% by mass, particularly advantageously less than 2% by mass, relative in each case to the dry mass or dry substance (DS) of the preparation.
The protein content is more than 50% by mass, advantageously more than 55% by mass, better more than 60% by mass, particularly advantageously more than 65% by mass (factor 6.25 and relative to DS).
The preparation contains a component of water-soluble carbohydrates such as mono-, di- and oligosaccharides. Since sucrose accounts for the largest proportion of the water-soluble carbohydrates, they will be denoted in the following text as the sucrose content. The sucrose content is less than 8% by mass, advantageously less than 4% by mass, better less than 2.5% by mass, still better less than 1% by mass, particularly advantageously less than 0.5% by mass (relative to DS).
The preparation has a light colour. The L*-value after grinding to a medium particle size d90 (d90: fraction of 90% of the mass of all particles smaller than the stated value) smaller than 250 μm is more than 70, advantageously more than 80, better more than 90, particularly advantageously more than 94.
The particle size of the preparation advantageously has a d90 value less than 500 μm, better less than 250 μm, advantageously less than 150 μm, particularly advantageously less than 100 μm.
The preparation has good to very good technofunctional properties, water binding in particular is greater than 1 mL/g, advantageously more than 2 mL/g particularly advantageously more than 3 mL/g, oil binding in particular is greater than 1 mL/g, advantageously more than 2 mL/g particularly advantageously more than 2.5 mL/g. The preparation has in particular an emulsifying capacity of more than 150 mL/g, advantageously more than 250 mL/g, better more than 400 mL/g particularly advantageously more than 500 mL/g. At pH 7, the preparation has in particular a protein solubility of more than 10%, better more than 20%, better more than 30%, advantageously more than 40%, advantageously more than 50%, particularly advantageously more than 60%. Surprisingly, despite a (protein) solubility less than 17% at pH 4.5 in some cases, the preparations according to the invention have been found to be extremely suitable for use as ingredients in fermented dairy alternatives with a pH of 4.5 (e.g., yoghurt or cream cheese substitute).
The preparation has good gelling properties. The minimum gelation concentration of the preparation is preferably ≤12% by mass, advantageously ≤10% by mass, better ≤8% by mass, particularly advantageously 6% by mass.
Optionally, the preparation contains fractions of alcohol, in particular ethanol, in quantities greater than 0.001% by mass, better >0.01% by mass, advantageously >0.1% by mass, particularly advantageously >0.5% by mass, but in each case less than 1% by mass. In such cases, it was found that the functional properties of the preparation remain at a very high level even with a content of 0.5% by mass.
Optionally, the preparation contains fractions of hexane in quantities greater than 0.0005% by mass, better >0.001% by mass, but in each case less than 0,005% by mass. Preparations with hexane contents in this order exhibit better functional properties than preparations with lower hexane content.

With regard to the properties of the preparation in the present patent application, the values indicated in % by mass refer in each case to the dry mass or dry substance of the protein preparation, with the exception of the fractions of solvents, which are stated as absolute mass fraction.

Surprisingly, preparations with fractions of organic solvents with the solvent contents indicated still have very good properties in terms of technofunctionality, for example very good texturising capability in the extruder, with formation of solid gel structures. The inventors were able to demonstrate that, despite the mild processing conditions and good technofunctional properties, preparations extracted with ethanol have a very low germ load, advantageously less than 1000 colony forming units (CFU) per gram preparation, advantageously less than 100 CFU, particularly advantageously less than 10 CFU per gram.

In advantageous variants, the preparation has additional properties, which may be extremely beneficial in various food applications. Thus for example, the content of water-soluble carbohydrates originally contained in the seeds may be reduced using suitable methods so that the proportion of proteins to soluble carbohydrate contents in the protein preparation is significantly greater than in almond seeds before processing. With appropriate processing, the proportion of the two values may be as much as 500% greater than in native almond seeds. This can yield advantages with regard to avoiding the formation of undesirable Maillard reactions in the production of foodstuffs, since Maillard products alter the colour of the food produced with the proteins, and the food product takes on a darker appearance a Maillard taste. This may be undesirable particularly in very pale coloured foodstuffs such as alternatives for milk or yoghurts, poultry or fish, or for delicatessen products. Thus, the carbohydrate-reduced almond protein preparation according to the invention is ideal for producing foodstuffs that are appealing to the senses, and which should contain only small quantities of Maillard products, or none at all. It has been found that even a reduction to values of less than 50% of the content of water-soluble carbohydrates in the protein preparation relative to the content of water-soluble carbohydrates in the raw material has the effect of considerably reducing the Maillard reaction when the protein is extruded, for example, or baked at temperatures above 130° C., and the resulting final product is lighter and more neutral to the senses than when a preparation with the content of water-soluble carbohydrates originally in the seeds is processed.

Surprisingly, after advantageous performance of the method according to the invention, protein contents of more than 60% by mass are obtained in the preparation according to the invention. In this way, using a very simple, inexpensive and highly sustainable method, high protein contents can be obtained without liberating the proteins from the press cake matrix, which are essential for many food applications.

### Description of the Method for Producing the Protein Preparation:

The method according to the invention includes a number of substeps, wherein almond seeds which have been cleaned, from which the hard shell has been removed, and with a hull fraction between 0 and 100% of the hull originally attached to the seeds, are provided and subsequently undergo processing. Optionally, after preliminary crushing or hydrothermal conditioning, these almond seeds are forwarded to a process for mechanical de-oiling, preferably with a continuous or interrupted press, e.g., an expeller press, an extruder or a hydraulic press, and the oil is extracted. Then, most of the oil and optionally some water-soluble carbohydrates, in particular sucrose, are removed from the press cakes obtained-advantageously after setting a defined particle size and a defined water content in the press cake—by solvent extraction. After this, the solvent is separated out of the preparation. Finally, the preparation is preferably ground to a defined particle size distribution. The process may advantageously be accompanied with sieving and screening processes. In the following text, the process will be described in detail:

### Cleaning:

In a first step, cleaned almond seeds are provided, or impurities or contaminants are removed from the almond seeds by mechanical methods. As a result, the fraction of contaminants is reduced to less than 0.5% by mass, advantageously less than 0.2% by mass, better less than 0.1% by mass, particularly advantageously less than 0.05% by mass, or almonds having an equally low contaminant fraction are provided.

### Partial Separation of the Testa (Optional):

In the following optional step, the seed coat is at least partially removed from the almonds. For this purpose, abrasive methods may be used, in which at least a portion of the seed coats is removed from the surface of the almonds by rubbing, clipping or grinding. The resulting husks with fractions of cotyledons attached thereto are forwarded to a separate oil recovery process, the almonds with the hull partly or entirely removed are forwarded to further processing according to the invention. As an alternative method for reducing the seed coat fraction, a process for separation under moist or wet conditions, advantageously at elevated temperatures may be carried out. In this context, either the almond seeds are steamed, heated or boiled before the hard shells are separated, and the hull is rubbed off mechanically after removal of the hard shell. Similarly, it may also be carried out if the previously peeled almond seeds are softened and heated in water or steam, and the seed coats are then removed. The method according to the invention is advantageously carried out using almonds from which the testa has been partly, mostly or entirely removed as the raw material. It is also possible to perform the method with almond seeds including the hulls in their entirety, and only to separate parts of the hulls later (e.g., after de-oiling), with sieves for example.

### Conditioning:

In one variant, the seeds are conditioned, with adjustment of the seed temperature and moisture before the mechanical partial de-oiling and optionally after comminution of the kernels. To this end, the water content in the seeds is adjusted to between 2 and 8% by mass, better between 3 and 6% by mass, particularly advantageously between 4 and 5.5% by mass. A coarse comminution of the kernels to an edge length of 0.5-7 mm, advantageously between 0.5 and 5 mm, particularly advantageously between 0.5 and 2 mm is also carried out before the mechanical partial de-oiling. Relevant portions of the hulls can be flaked off by coarse comminution, in an impact mill or blade granulator for example, and these can advantageously be separated from the kernels by screening or other separation processes. This permanently improves the colour of the almond protein preparations. It has also been found that the oil yield is higher if the almond seeds have been ground beforehand. It is also advantageous to heat the seeds to a temperature above 40° C., advantageously above 50° C., better above 60° C., particularly advantageously above 70° C. but below 100° C., particularly advantageously below 80° C. before or after the comminution and before the mechanical partial de-oiling. After conditioning of this nature, the almond seeds can be processed particularly effectively in a continuous press. The mechanical partial de-oiling may be carried out according to the invention either with almond seeds with the hulls still completely attached or with almond seeds from which the hulls have been partially or completely separated by suitable pretreatment.

### Mechanical Partial De-Oiling:

With the almond seeds having optionally undergone preliminary conditioning, the oil is extracted mechanically, advantageously with the aid of continuous de-oiling apparatuses. Examples of such machines are expeller presses, extruders or interrupted hydraulic presses, although other mechanical apparatuses such as centrifugal separation devices may also be used to separate the oil. In the particularly advantageous pressing of the seeds to yield p press cakes and oil using expeller presses or extruders, pressing is carried out in such a way that the residual oil content after pressing is more than 8% by mass but less than 40% by mass, residual oil content is advantageously between 8 and 30% by mass, better between 8 and 25% by mass, and particularly advantageously between 8 and 20% by mass. These values also apply if pressing is not carried out, but other methods of mechanical partial de-oiling are used. The setting of the lower residual oil content limit at 8% was found because significantly higher shearing rates, pressing pressures and temperatures are required to separate any more oil, and these may be factors in damaging the proteins.

Almond seeds have an oil content up to 60%, and they cannot easily be de-oiled by mechanical means due to the absence of structuring components for drainage. In order to reduce the amount of solvent required for solvent extraction, it will therefore be attempted to obtain a residual oil content less than 20% by mass in the press cake after mechanical partial de-oiling. Consequently, it may be necessary to subject the press cake to another pressing process and/or further de-oiling using a device for mechanical partial de-oiling, in particular an expeller. This may be done when pressing by introducing the press cake into the feed of the first pressing together with unpressed seeds, or in another, second press which only presses the press cake further. The pressing or mechanical partial de-oiling of the press cake may also be carried out multiple times in order to reach the desired residual oil content. If the press cake is pressed or mechanically partially de-oiled multiple times, the desired low residual oil content can ultimately be attained without having to set overly high temperatures.

In order to avoid damaging the proteins too severely by the repeated mechanical partial de-oiling, the mechanical partial de-oiling is carried out according to the invention at moderate temperatures. Advantageously, the almonds are pressed or mechanically partially de-oiled at an average temperature below 100° C., particularly advantageously below 80° C. In this context the average temperature is understood to be the arithmetical average of the temperature of the seeds at the intake and the temperature of the press cake at the outlet from the expeller or the mechanical partial de-oiling device. This enables gentle pressing of the oil despite multiple pressing passes without the need to deal with significant colour changes in the preparation.

### Optional Conditioning of the Press Cake or Partially De-Oiled Almond Seeds:

In an advantageous variant of the method according to the invention, the press cakes or partially de-oiled almond seeds may undergo a further conditioning cycle prior to an extraction before further processing to separate the residual oil and reduce the fraction of sucrose in the press cakes or partially de-oiled almond seeds. In such a case, it has been found that lowering the moisture level in the press cakes or partially de-oiled almond seeds to a residual moisture less than 8% by mass, advantageously less than 5% by mass, better less than 3% by mass, particularly advantageously less than 2% by mass, with the aid of dryers, for example, makes the de-oiling with organic solvents in the subsequent step more efficient, as more oil can be separated with less solvent with lower moisture. This may be used advantageously to reduce costs and help to preserve the proteins.

It is also advantageous the change the size and shape of the particles in the press cakes or partially de-oiled almond seeds before or during the extraction. This is particularly significant because press cakes of almond seeds tend to form very solid, occasionally hard discs, flakes or press cake structures, making penetration by organic solvents more difficult if not impossible. It was found that grinding the press cake or partially de-oiled almond seeds to particle sizes with a d90 value less than 2 mm, advantageously less than 1 mm, better less than 0.5 mm, particularly advantageously less than 0.2 mm speeds up the extraction considerably. This acceleration leads to an improvement in the functional properties of the preparations since the residence time in the dryer before the extraction and the contact time between solvents and proteins can be shortened. According to the invention however, the fine grain fraction with a particle size smaller than 100 μm in the ground press cakes or almond seed mass should be less than 50% by mass, advantageously less than 25% by mass, particularly advantageously less than 10% by mass.

It is also possible, and for percolation extraction advantageous, if the press cake or partially de-oiled almond seeds is/are not ground but flaked. In this case, the flake thickness is advantageously set to less than 2 mm, advantageously less than 0.5 mm, particularly advantageously less than 0.2 mm. For these purposes, flake thickness is understood to be the average thickness of the material leaving the roller mill or other flaking unit. The average thickness can be determined by measuring with a calliper gauge or micrometre screw, for example, it corresponds to the average from 50 measurements.

In the case of mechanical partial de-oiling with an expeller, various methods can be used to adjust the size and shape of the particles in the press cake. For example, mills or crushers with appropriate sieve inserts, or roller frames with defined roller gaps may be used. In such situations, particle size distributions with a defined size spectrum may be obtained. These can be evened out after or during grinding by separating according to size, e.g., by sieving with respect to the particle size distribution.

Comminution in a suspension has proven to be particularly advantageous. In this way, fast flowing liquids may also be used as a pressure jet or solid-containing suspensions to comminute the press cake particles. In this context, conveyor units, agitators or mixers that cause shear loading on the press cake may be used as well as liquid nozzles to comminute the particles, and in so doing to constantly create a new surface to facilitate penetration by the solvent. Units that are active in the process in any case for transporting the extraction agent are advantageously shared for this purpose. In this way, it is possible to use units that are actually designed for pumping or mixing, e.g., centrifugal pumps or forms of conveyor machinery or agitating devices that input high shearing forces into the suspension of press cake and solvent, for the comminution. By selecting suitable residence time in these units or by recirculation, comminution in said units may be adjusted successfully so that the particle size distribution according to the invention is achieved.

### Solvent Extraction:

In order to separate oil and sucrose from the press cakes or partially de-oiled almond seeds, mixtures of alcohols with water are preferably used as solvents. In such cases, the treatment with alcohol and the treatment with water may be carried out simultaneously in the same extraction step (in the form of an alcohol-water mixture) or arranged to take place consecutively. Additionally, hexane may also be used in the presence of water as the solvent, as well as combinations of alcohol or hexane as one solvent and water as another solvent. Examples of alcohols that may be used are ethanol, propanol, isopropanol or others. To ensure that as much oil as possible is separated out of the press cakes or partially de-oiled almond seeds, the mass fraction of solvent relative to the mass fraction of press cake or partially de-oiled almond seeds should be chosen to be more than 1.5, advantageously more than 3, better more than 5, better still more than 7, particularly advantageously more than 10. In this way, it is possible to achieve a substantial reduction of the oil to less than 2% by mass.

When the organic solvents alcohol or hexane are used for the extraction, it is advantageous if a fraction of water is present as well as the organic solvent during the extraction. This can be assured by adding water, or by using an organic solvent with a defined water content, or by adding in water via a moist press cake. The water may be added while the oil is extracted with solvent or afterwards. If organic solvent and water are added at the same time and a suitable water content is chosen, not only can most of the oil be separated out of the press cakes or almond seeds, but a fraction of sucrose and at the same polar and amphiphilic phytochemicals can also be removed simultaneously. To this end, the water content in the extraction relative to the organic solvent is selected to be more than 6% by mass, advantageously more than 7% by mass, particularly advantageously more than 8% by mass, better more than 9% by mass, better still more than 10% by mass. Surprisingly, if alcohol for example, in particular ethanol, is used as the solvent, de-oiling can still take place even with water fractions at such high levels without damaging the proteins too severely. However, if alcohols are used as the organic solvent, the water content should be chosen to be less than 14% by mass, otherwise the oil will no longer be sufficiently soluble. With this limitation, it is possible to obtain a protein preparation with technofunctional properties that has a particularly pale colour and very high protein content, more than 60% by mass.

As was noted earlier, the water content in the extraction process may be assured by providing water-containing solvent, by the addition of press cakes or partially de-oiled almond seeds having residual moisture, or by direct addition of water before or during the solvent extraction. Combinations of said measures may also be selected. If in one variant hexane is used as the organic solvent, the water content may also be adjusted so that it has a value above 14% by mass relative to the hexane used. In the case of hexane, the good solubility of the oil is retained even if water contents more than 20 or up to 30% by mass, preferably <30% by mass relative to the solvent are used. Thus, the water content according to the invention is only limited to a maximum of 14% by mass in amphiphilic solvents such as alcohol, this limitation does not apply for a lipophilic solvent.

It is possible that while the oil and sucrose are being separated during treatment of the protein-rich almond seeds or almond seed press cakes with water-alcohol mixtures, denaturation of the proteins may also take place. There is only a small process window for this simultaneous separation step in order to largely avoid this effect. This involves not only the defined water content, but also the temperature and residence time. According to the invention, the temperature of the solvent or solvent mixture will therefore be between 30° C. and 75° C., advantageously between 45° C. and 65° C., particularly advantageously between 50° C. and 65° C. during the extraction. In this temperature range, the selected mixtures of water and organic solvent are capable of separating both oil and sucrose out of the almonds without also causing excessively extensive denaturation of the proteins. The duration of the contact between organic solvent and the press cakes or the protein preparation at temperatures higher than 45° C. is between 30 minutes and 12 hours, advantageously between 1 hour and 5 hours, particularly advantageously between 1 and 2 hours in the method according to the invention. However, the temperature ranges indicated above should also be chosen if for example nonpolar solvents such as hexane are used, in order to avoid thermal damage to the proteins as far as possible.

For the extraction, a conventional percolation extraction may be performed in which a stream of solvent flows over the bulk material of press cake particles of particles that have been conditioned with respect to particle size/shape or moisture, so that oil and sucrose can be eluted into the organic solvent or the water. Since in this process fine particles can be stripped from the almond press cakes and carried out together with the solvent, filtration apparatuses must be provided to prevent clogging of pumps and pipelines or losses of product. In order to preclude or at least minimise this process, it may be advantageous to press the conditioned or unconditioned press cake into pellets before the extraction; considerably fewer fine particles will then be washed out during the extraction. This in turn can significantly reduce the filtration requirements.

Since it is not possible to entirely avoid loss of fine particles during the percolation extraction, immersion extraction, preferably in a mixing-settling process for example, offers particular benefits. A multistage immersion extraction arrangement is particularly advantageous. With this method, the press cakes or conditioned press cakes are immersed fully in the solvent, with the result that practically no gas comes into contact with the particles. Accordingly, it is possible in an immersion extractor to comminute the particles as described above by intense mixing with an agitator simultaneously with the extraction. This also makes it possible to carry out incremental comminution of the press cakes selectively into different particle sizes in several extraction receptacles arranged one behind the other.

This may be carried out as follows: After the first extraction step, solvents and the coarse particulate raffinate can easily be separated mechanically, advantageously by sedimentation or centrifugation e.g., in decanters. The oil-containing miscella in the supernatant can then be distilled, and the recovered solvent can be reused for the extraction of press cake particles which have already been extracted one or more times, which have a smaller particle size distribution than in the preceding extraction. The press cake separated from the solvent (raffinate) can be mixed with fresh solvent, and so de-oiled again. The solvent supernatant from the treatment of a raffinate charged with less oil can be reused to reduce the overall quantity of solvent for extraction of a raffinate charged with more oil, and so on. Thus, a counterflow extraction system is established, with stirring tanks that contain particle size distributions of different sizes.

A particular advantage of implementing sedimentation is derived from the ability to specify the sedimentation duration in order to adjust the solid-liquid separation selectivity. In this context, after an extraction that is carried out with defined particle size distribution, sedimentation proceeds in the Earth's gravitation field after the agitation has stopped, until a defined volume ratio of raffinate and supernatant is reached. In this situation it is beneficial to separate the supernatant from the raffinate, from above, for example, by pumping out, lifting out or aspirating upon reaching a previously defined volume fraction of the supernatant of at least 50%, advantageously more than 60%, particularly advantageously more than 70%.

The raffinate may be charged with solvent again in counterflow, and the suspension may be agitated until a new particle size distribution is established by the shearing created during the agitation. Then, the sedimentation process takes place again. The sequence of mixing and sedimentation of the raffinate may be repeated multiple times, the operation is advantageously carried out more than twice, better more than three times, particularly advantageously more than four times, so that the extraction is performed in multiple stages, particularly advantageously in a counterflow process. In one variant of the method, it is advantageous to use different mixture ratios of organic solvent and water in different stages of the multistage extraction. Thus, in the first extraction stage, in which the fresh press cake is used, a higher water content may be used to selectively separate water-soluble components, in subsequent extraction steps a lower water content may be selected in order to make the separation of oil more efficient, since for example a solvent such as ethanol or isopropanol is able to dissolve more oil with a lower water fraction. This procedure also has the advantage that, when ethanol is used as the solvent for example, the water content is high only briefly in the first extraction stage, so protein denaturation can be minimised. This variation in the water content is advantageously supported if after the second and/or third extraction a part of the supernatant from each extraction is not used for the next extraction but is treated together with the miscella. Surprisingly, it was found that in this way denaturation of the proteins in almond seeds can be reduced if solvents or solvent mixtures with different water contents and polarities are used in different extraction stages.

Besides mixing water and an organic solvent such as ethanol in an extraction step, it may also be advantageous to initially use a lipophilic solvent such as hexane or a less polar solvent such as ethanol with a water content less than 5% by mass for the first extraction steps, and then to use a hydrophilic solvent or a solvent mixed with more water after partial separation of the solvent or complete desolventing of the raffinate. This can further reduce the strain on the proteins due to the presence of water.

Post-treatment and desolventing of the preparation: Following the extraction with organic solvents and water, in order to improve the functional properties, the preparation may optionally be treated further with aqueous enzyme solutions or by fermentation, or it may be dried straight away. The drying is advantageously carried out at low temperatures, below 120° C. in the product, better below 100° C., particularly advantageously below 80° C., in order to preserve the proteins and to keep the colour in the preparation as light as possible. Advantageously, a dryer will be used for this, which does have a shell temperature above 100° C., better above 120° C., but which is operated in a vacuum, and the pressure of which is reduced again when drying is finished in order to separate the solvent residues. The pressure is advantageously reduced to values of less than 500 mbar, better less than 200 mbar, particularly advantageously less than 100 mbar. The pressure reduction when drying is ended has the effect of lowering the solvent's boiling point, and the shell temperature can be reduced. Lowering the temperature of the mantle in this way during post-drying has the effect of more gentle treatment of the proteins.

Drying is advantageously followed by grinding of the dried protein preparations to modify the functionality, because preparations that have been ground to different degrees of fineness exhibit considerable variations in their technofunctional properties, e.g., their solubility. Grinding is therefore carried out depending on the application to d90 particle sizes less than 500 μm, advantageously less than 250 μm, better less than 150 μm, particularly advantageously less than 100 μm.

Post-treatment and desolventing of the miscella: The miscella charged with oil and water is advantageously separated by distillation, and optionally concentrated by rectification. It has been found that the sugars and some secondary phytochemicals remain in the water phase, and can be separated from the oil phase mechanically, e.g., by centrifuging or in the gravitational field.

The method according to the invention offers further advantages for the safety of the almond preparation. Since fractions of bitter almonds (almonds with high cyanogenic glycoside content) can always be contained in sweet almonds (almonds with very low cyanogenic glycoside content), the extractive method enables partial separation of the cyanogenic glycosides contained with amphiphilic or hydrophilic solvents, so—unlike pure press cakes—they do not pose a danger to humans.

### Description of a Use of the Preparation:

Use of the inventive preparation from almond seeds yields particular advantages when protein mixtures are produced with other protein ingredients for food products or petfood. Due to its highly appealing sensory properties, unpleasant flavours from other raw materials in the mixture, e.g., from pea protein, which increases consumer acceptance.

A mixture of the preparation according to the invention with fractions of legume protein from the group of peas, lentils, beans, broad beans, peanuts or soya is advantageous, a mixture with fractions from just the group of peas and soya is particularly advantageous, just peas is particularly advantageous.

A mixture of the named proteins with the almond preparation according to the invention should contain >60% by mass, advantageously >70% by mass, particularly advantageously >80% by mass protein content. The ratio between the protein according to the invention and the total mass of the mixture should be more than 5% by mass and less than 95% by mass, advantageously more than 10% by mass and less than 90% by mass, particularly advantageously more than 25% by mass and less than 75% by mass, optimally more than 40% by mass and less than 60% by mass. This represents the ideal formula for combining the functionality of the legume proteins with the sensory appeal and colour of the preparation according to the invention and compensating for the deficits of individual amino acids in the individual proteins of the mixture.

In the text below, the quantitative characterization of the protein preparations produced is based on the following determination procedures:

### Protein Content:

The protein content is defined as the content which is calculated by multiplying the nitrogen determination according to Duma with a factor of 6.25. In the present patent application, the protein content is specified in percent by mass relative to the dry substance (DS), that is to say the anhydrous sample.

### Colour:

The perceptible colour is defined using CIE-L*a*b* colorimetry. In this context, the L* axis indicates the brightness an, wherein Black has a value of 0 and White a value of 100. The a* axis describes the Green or Red component, and the b* axis describes the Blue or Yellow component.

### Protein Solubility:

The protein solubility is determined using determination methods according to Morr et al. 1985, see the journal article: Morr C. V., German, B., Kinsella, J. E., Regenstein, J. M., Van Buren, J. P., Kilara, A., Lewis, B. A., Mangino, M. E, “A Collaborative Study to Develop a Standardized Food Protein Solubility Procedure. Journal of Food Science”, volume 50 (1985) pages 1715-1718). Protein solubility can be stated for a defined pH, if a pH is not indicated, the data refers to a pH of 7.

### Emulsifying Capacity:

The emulsifying capacity is determined using a determination method (referred to in the following as EC determination method) in which 100 ml of a 1% suspension of the protein preparation at pH 7 is added to maize germ oil until phase inversion of the oil-in-water emulsion takes place. The emulsifying capacity is defined as the maximum oil uptake capacity of this suspension, determined through the spontaneous loss of conductivity due to the phase inversion (see the journal article by Wasche, A., Müller, K., Knauf, U., “New processing of lupin protein isolates and functional properties”. Nahrung/Food, 2001, 45, 393-395) and is stated e.g., in ml oil/g protein preparation, i.e., millilitres of emulsified oil per gram of protein preparation

Fat Content (Synonymous with Oil Content):

The fat or oil content is determined in accordance with the Soxhlet method using hexane as solvent.

### Content of Cyanogenic Glycosides as Prussic Acid (HCN):

Expressed as HCN content in mg HCN per kg preparation (relative to DS), calculated using HPLC from the guide substances linustatin and neolinustatin based on Schilcher, H. & Wilkens-Sauter, M. (1986). Quantitative determination of cyanogenic glycosides in Linum usitatissimum using HPLC. Fats Soaps Paints, 88, 287-290.

### Sucrose:

The sucrose content is determined by means of modified measurement according to DIN 10758:1997-05 (incl. Corrigendum 1 of Sep. 2018) with HPLC method. To prepare the sample, the sugars are extracted from the sample matrix with hot water. After impurities have been separated, the extracts are topped up with water to a defined volume and filtered, and the filtrates are transferred for HPLC measurement.

### Water Binding:

The water binding capacity is calculated according to the method as described in: American Association of Cereal Chemists, “Approved methods of the AACC”. 10th ed., AACC. St. Paul, MN, 2000b; Method 56-20. “Hydration capacity of pregelatinized cereal products”. Water binding capacity may be expressed in ml/g for example, i.e. millilitres of bound water per gram preparation, and is determined according to the AACC determination method using the weight of the sediment saturated with water minus the initial weight of the dry preparation after mixing approx. 2 g protein preparation with approx. 40 ml water for 10 minutes and centrifuging at 1000 g for 15 minutes at 20° C.

### Oil Binding:

The oil binding capacity may be expressed in ml/g, i.e. millilitres of bound oil per gram preparation, and is measured according to centrifuge determination procedures as the volume of the oil-binding sediment after mixing 1.5 g protein preparation with 15 ml maize germ oil for 1 minute and centrifuging at 700 g for 15 minutes at 20° C.

### Minimum Gelation Concentration:

The minimum gelation concentration determines the concentration at which a protein preparation can form a thermally induced gel. The preparation is added to water in various concentrations in test tubes and suspended uniformly. The suspension is then heated to 85° C. for 30 minutes and cooled to 20° C. again. The test tube is inverted to allow free water to drain out. The lowest concentration at which no water flows out is described as the minimum gelation concentration. The lower the value of the minimum gelation concentration in % by mass of protein preparation, the more suitable the protein preparation is for use as a gelling agent.

### Performance Example

800 g of an almond seed press cake with an oil content of 20% by mass, which was recovered using an expeller at an average temperature of 75° C. by one-time pressing from almond seeds without testa (hull), was dried in a dryer until the water moisture level was 2.5% by mass, and the press cake was crushed coarsely into fragments with an edge length of 1 mm using a mortar. The crushed press cake was extracted 5 times with 3500 mL solvent (ethanol-water mixture with 7% by mass water content) each time. For this, in the first stage 3500 mL was added to the 800 g press cake, stirred for 5 minutes at 58° C., the agitator was then switched off. The solid was allowed to form a sediment for 30 minutes, after which 2500 mL supernatant was drawn off and a further 2500 mL solvent was added. The subsequent extraction steps were performed similarly, in each case 2500 mL was added and 2500 mL drawn off. Then the final raffinate or sediment was dried in a drying cupboard for 24 hours and then ground. Grinding was carried out with a 250 μm sieve insert. The preparation had a pleasantly nutty flavour and a protein content of 69% relative to DS, a protein solubility of 68% at pH 7 and an emulsifying capacity of 535 mL/g. In the L*a*b measurement, an L* value of 95 was determined. A content of cyanogenic glycosides measured as prussic acid was not detectable. Other properties of the preparation obtained are presented in the following tables.

TABLE 1
L*a*b* colour values of the preparation and an aqueous suspension

| | Colour value | | |
|---|---|---|---|
| Colour values | L* | a* | b* |
| Almond protein preparation as flour | 95.0 | −0.3 | 5.4 |
| Aqueous suspension with 10% by mass flour | 87.1 | −0.8 | 16.3 |

TABLE 2
Composition of the raw materials and preparations

| | | Ash | Ash | | | |
|---|---|---|---|---|---|---|
| | DS | (550° C.) | (950° C.) | Protein | Oil | Sucrose |
| Preparation | [%] | [% DS] | [% DS] | [% DS] | [% DS] | [% DS] |
| Almond protein | 94.7 | 7.8 | 7.4 | 69.0 | 3.3 | 2.3 |
| preparation, pressed, | | | | | | |
| extracted with ethanol- | | | | | | |
| water mixture | | | | | | |
| Almond protein | 93.3 | 5.7 | 5.3 | 60.5 | 3.3 | 11.9 |
| preparation, extracted with | | | | | | |
| hexane with no added | | | | | | |
| water | | | | | | |
| Almonds before treatment | 96.0 | 2.9 | 2.2 | 24.7 | 57.9 | 5.0 |

TABLE 3
Functional properties of the preparations

| | | | Emulsifying | Min. gel | Water | |
|---|---|---|---|---|---|---|
| Functional | Protein solubility [%] | | capacity | conc. | binding | Oil binding |
| properties | pH 4.5 | pH 7.0 | [mL/g] | [%] | [mL/g] | [mL/g] |
| Almond protein | 16.2 | 68.3 | 535 | 6.0 | 3.1 | 1.8 |
| preparation, | | | | | | |
| extracted with | | | | | | |
| ethanol-water | | | | | | |
| mixture | | | | | | |

### Application Example

50 g of the almond seed preparation from the performance example was added to a muffin recipe. Muffins were baked with the dough, and the sensory impression of the muffins was evaluated. The appearance was very attractive, the muffins had a loose crumb, a brown crust and a very pleasant taste.

1. Protein preparation produced from almond seeds, with a
protein content of more than 50% by mass relative to the dry mass, and
an oil content less than 6% by mass relative to the dry mass, determined according to the Soxhlet Method using hexane as solvent,
wherein the protein preparation has
a sucrose fraction of less than 8% by mass relative to the dry mass, and
a brightness L* greater than 70, determined according to CIE-L*a*b* colorimetry with a d90 particle size of the protein preparation smaller than 250 μm or after grinding the protein preparation to a d90 particle size smaller than 250 μm.

2. Protein preparation according to claim 1,
which has a brightness L* greater than 80, preferably greater than 90, particularly preferably greater than 94.

3. Protein preparation according to claim 1,
in which the sucrose fraction is less than 4% by mass, preferably less than 2.5% by mass, particularly preferably less than 1% by mass or less than 0.5% by mass relative to the dry mass.

4. Protein preparation according to claim 1,
in which the protein content is more than 55% by mass, preferably more than 60% by mass, particularly preferably more than 65% by mass.

5. Protein preparation according to claim 1,
in which the oil content is less than 4% by mass, preferably less than 3% by mass, particularly preferably less than 2% by mass.

6. Protein preparation according to claim 1,
in which the emulsifying capacity, determined according to the EC determination procedure referred to in the description, is more than 150 ml/g, preferably more than 250 ml/g, particularly preferably more than 400 ml/g or more than 500 ml/g.

7. Protein preparation according to claim 1,
in which the water binding, determined according to the AACC determination procedure referred to in the description, is more than 1 ml/g, preferably more than 2 ml/g, particularly preferably more than 3 ml/g.

8. Protein preparation according to claim 1,
in which the oil binding, determined according to the centrifuge determination procedure referred to in the description, is more than 1 ml/g, preferably more than 2 ml/g, particularly preferably more than 2.5 ml/g.

9. Protein preparation according to claim 1,
which has a protein solubility in water at pH 7 that has a value of more than 10% or more than 20%, preferably more than 30% or more than 40%, particularly preferably more than 50% or more than 60%.

10. Protein preparation according to claim 1,
which has a fraction of alcohol, in particular ethanol, of >0.001% by mass, preferably >0.01% by mass, particularly preferably >0.1% by mass or >0.5% by mass, but which is less than 1% by mass.

11. Protein preparation according to claim 1,
which has a hexane fraction of >0.0005% by mass, preferably >0.001% by mass, but less than 0.005% by mass.

12. Protein preparation according to claim 1,
which has a d90 particle size of less than 500 μm, preferably less than 250 μm, advantageously less than 150 μm, particularly preferably less than 100 μm.

13. Protein preparation according to claim 1,
to which legume proteins from the group of peas, lentils, beans, broad beans, peanuts or soya, preferably only from the group of peas and soya, particularly preferably only peas were added.

14. Use of the preparation according to claim 1 as an ingredient in foodstuffs, petfood and animal feed.

15. Method for obtaining a protein preparation from almond seeds, in particular according to claim 1, with at least the following steps:
mechanical partial de-oiling of the almond seeds;
performance of one or more extraction steps for further de-oiling of the partially de-oiled almond seeds, optionally after grinding or flaking, to attain a residual oil content of less than 6% by mass, in which a sucrose fraction is also separated,
wherein the one or more extraction steps is/are performed with one or more alcohol-water mixtures or with alcohol or hexane as solvent in the presence of or with the addition of water, each having a water fraction in the range between >6% by mass and <14% by mass for alcohols, and between >6% by mass and <30% by mass for hexane, or wherein the multiple extraction steps are performed with alcohol or hexane as a first solvent and with water as a second solvent; and
drying the raffinate that is obtained after performance of the one or more extraction steps.

16. Method according to claim 15,
in which the almond seeds are provided with a residual fraction of hulls in dry substance of less than 100% by mass, preferably less than 75% by mass, better less than 50% by mass, particularly preferably less than 10% by mass relative to hulls originally contained in the almond seeds in dry substance, or the hulls are removed until this residual fraction is attained.

17. Method according to claim 15,
in which an average temperature of the almond seeds during the mechanical partial de-oiling is kept below 100° C., preferably below 80° C.

18. Method according to claim 15,
in which the further de-oiling of the partially de-oiled almond seeds is carried out until a residual oil content of less than 4% by mass, preferably less than 3% by mass, particularly preferably less than 2% by mass is attained.

19. Method according to claim 15,
in which the one or more extraction steps is/are performed with one or more alcohol-water mixtures as solvent, or with alcohol as solvent in the presence of water, wherein the water fraction is in the range between >7% by mass and <14% by mass, preferably between >10% by mass and <14% by mass in each case.

20. Method according to claim 15,
in which the one or more extraction steps is/are performed with hexane as solvent in the presence of water, wherein the water fraction is in the range between >10% by mass and <30% by mass in each case.

21. Method according to claim 15,
in which the water fraction is selected to be highest for the first stage and lower for one or more subsequent stages in a multistage extraction.

22. Method according to claim 15,
in which a temperature of the solvent during the performance of the one or more extraction steps is selected to be between 30° C. and 75° C., preferably between 45° C. and 65° C., particularly preferably between 50° C. and 65° C.

23. Method according to claim 22,
in which a duration of the contact between the solvent and the partially de-oiled, optionally ground or flaked almond seeds is selected to be between 30 minutes and 12 hours, preferably between 1 hour and 5 hours, particularly preferably between 1 and 2 hours at temperatures of the solvent >45° C.

24. Method according to claim 15,
in which the mechanical partial de-oiling is carried out until a residual oil content is attained between >8% by mass and <40% by mass, preferably between >8% by mass and <30% by mass, particularly preferably between >8% by mass and <25% by mass, or between >8% by mass and <20% by mass.

25. Method according to claim 15,
in which the almond seeds are conditioned before the mechanical partial de-oiling by adjusting the moisture of the seeds to a water content in the seeds between 2 and 8% by mass, preferably between 3 and 6% by mass, particularly preferably between 4 and 5.5% by mass.

26. Method according to claim 15,
in which the almond seeds are heated before the mechanical partial de-oiling to a temperature >40° C., preferably >50° C., advantageously >60° C., particularly preferably >70° C., but <100° C., better <80° C.

27. Method according to claim 15,
in which the almond seeds are coarsely comminuted before the mechanical partial de-oiling to an edge length between 0.5 and 7 mm, advantageously between 0.5 and 5 mm, particularly preferably between 0.5 and 2 mm.

28. Method according to claim 15,
in which the partially de-oiled, optionally coarsely comminuted, ground or flaked, almond seeds are conditioned before performance of the one or more extraction steps by lowering of the moisture to a residual moisture of <8% by mass, preferably <5% by mass, particularly preferably <3% by mass or <2% by mass.

29. Method according to claim 15,
in which a particle size of the partially de-oiled almond seeds is adjusted to a d90 value of <2 mm, preferably <1 mm, particularly preferably <0.5 mm or <0.2 mm before or during performance of the one or more extraction steps, wherein a fine grain fraction with a particle size less than 100 μm preferably has a vale <50% by mass, particularly preferably <25% by mass or <10% by mass.

30. Method according to claim 15,
in which the partially de-oiled almond seeds are flaked before performance of the one or more extraction steps to a flake thickness of <2 mm, preferably <0.5 mm, particularly preferably <0.2 mm.

31. Method according to claim 15,
in which the drying of the raffinate is carried out at a temperature of <120° C., preferably <100° C., particularly preferably <80° C.

32. Method according to claim 15,
in which the drying of the raffinate is carried out in a vacuum dryer, wherein when drying is ended the pressure is reduced to <500 mbar, preferably <200 mbar, particularly preferably <100 mbar.

33. Method according to claim 15,
in which a treatment of the raffinate with aqueous enzyme solutions or by fermentation is carried out before drying of the raffinate.

34. Method according to claim 15,
in which after drying the raffinate is ground to a defined particle size distribution with a d90 value of <500 μm, preferably <250 μm, particularly preferably <150 μm or <100 μm.
